(19) United States
(12) Patent Application Publication
(10) Pub. No.: US 2008/0219552 A1
(43) Pub. Date: Sep. 11, 2008

(54) Color identifying apparatus and color identifying method

(75) Inventor: Toshihiro Ogasawara, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 12/010,551

(22) Filed: Jan. 25, 2008

(30) Foreign Application Priority Data
Jan. 26, 2007 (JP) 2007-016641

(51) Int. Cl. G06K 9/00

(52) U.S. Cl. 382/170

(57) ABSTRACT

A color identifying apparatus for identifying the color of a reaction surface which has caused a color reaction with a gas to be specified comprises a histogram storage for storing a plurality of associated sets of identifying information and a reference histogram of R, G, B signal intensities, which are generated from RGB bitmap data images of reaction surfaces which have caused color reactions with gases, and the frequencies of the signal intensities, said identifying information being used for identifying the reaction surfaces, an image capturing unit for capturing an image of the reaction surface and generating RGB bitmap images of the reaction surface, an arithmetic unit for generating a histogram of RGB signal intensities and the frequencies thereof from the RGB bitmap images generated by the image capturing unit, checking the generated histogram against the reference histograms stored in the histogram storage to specify one of the reference histograms which corresponds to the generated histogram, and specifying the identifying information which is related to the specified reference histogram, and an output unit for outputting the specified identifying information.

This application is based upon and claims the benefit of priority from Japanese patent application No. 2007-16641, filed on Jan. 26, 2007, the disclosure of which is incorporated herein in its entirety by reference.

### BACKGROUND OF THE INVENTION

1. Field of the Invention

The present invention relates to a color identifying apparatus and a color identifying method, and more particularly to a color identifying apparatus and a color identifying method for specifying a gas by identifying the color of a reaction surface which is produced by a color reaction with the gas.

2. Description of the Related Art

There have heretofore been known gas detecting devices for causing a chemical reaction between a gas such as a toxic gas and chemical reagents to change the colors of the chemical reagents. For example, U.S. Pat. No. 6,228,657B1 discloses an M256 chemical agent detection kit.

The gas detecting device includes a plurality of ampules containing respective chemical reagents of different types and a plurality of reaction surfaces such as paper surfaces. When the ampules are crushed, the chemical reagents contained therein flow into the reaction surfaces.

The chemical reagents as they flow into the reaction surfaces chemically react with a gas that is held in contact with the reaction surfaces. The chemical reaction causes the chemical reagents to change their colors, and the reaction surfaces also change their colors depending on the color changes of the chemical reagents.

The user of the gas detecting device introduces different chemical reagents into the respective reaction surfaces, and recognizes the concentration of the gas based on the color changes of the reaction surfaces.

U.S. Pat. No. 6,228,657B1 also reveals a reader device for outputting a signal depending on the color of a reaction surface using three photodiodes or a single color CCD sensitive to the colors of R, G, B (red, green, and blue).

A reaction surface may suffer color irregularities during the color reaction. For example, the reaction surface may develop a plurality of areas having different colors.

The reader device disclosed in U.S. Pat. No. 6,228,657B1 does not include any way to deal with such color irregularities on reaction surfaces. Consequently, the disclosed reader device may possibly recognize a color produced by averaging different colors on a reaction surface, i.e., a color that is different from the actual colors on the reaction surface, as the color of the reaction surface.

### SUMMARY OF THE INVENTION

An exemplary object of the invention is to provide a color identifying apparatus and a color identifying method which are capable of highly accurately identifying the color of a reaction surface regardless of color irregularities of the reaction surface during a color reaction.

A color identifying apparatus according to an exemplary aspect of the invention is a color identifying apparatus for identifying a color of a reaction surface which has caused a color reaction with a gas to be specified, the color identifying apparatus includes: a histogram storage that stores a plurality of associated sets of identifying information and a reference histogram of R, G, B signal intensities, which are generated from RGB bitmap data images of reaction surfaces which have caused color reactions with gases, and the frequencies of the signal intensities, the identifying information being used for identifying the reaction surfaces; an image capturing unit that captures an image of the reaction surface and generates RGB bitmap images of the reaction surface; an arithmetic unit that generates a histogram of RGB signal intensities and the frequencies thereof from the RGB bitmap images generated by the image capturing unit, checks the generated histogram against the reference histograms stored in the histogram storage to specify one of the reference histograms which corresponds to the generated histogram, and specifies the identifying information which is related to the specified reference histogram; and an output unit that outputs the identifying information specified by the arithmetic unit.

A color identifying method according to an exemplary aspect of the invention is a color identifying method adapted to be carried out by a color identifying apparatus including a histogram storage, the color identifying method includes: storing, in the histogram storage, a plurality of associated sets of identifying information and a reference histogram of R, G, B signal intensities, which are generated from RGB bitmap data images of reaction surfaces which have caused color reactions with gases, and the frequencies of the signal intensities, the identifying information being used for identifying the reaction surfaces; capturing an image of the reaction surface and generating RGB bitmap images of the reaction surface; generating a histogram of RGB signal intensities and the frequencies thereof from the generated RGB bitmap images; specifying one of the reference histograms which corresponds to the generated histogram by checking the generated histogram against the reference histograms stored in the histogram storage; specifying the identifying information which is related to the specified reference histogram; and outputting the specified identifying information.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram of a color identifying device according to an exemplary embodiment of the present invention;

FIG. 2 is a perspective view of color sample board 10;

FIG. 3 is a diagram showing by way of example reaction surface 103 which has caused a color reaction with gas A;

FIG. 4 is a diagram showing a histogram of frequencies of signal intensities of color sample A;

FIG. 5 is a diagram showing by way of example a reaction area (color irregularities) 103b developed by the color reaction with gas A;

FIG. 6 is a diagram showing a histogram of frequencies of signal intensities of color sample B;

FIG. 7 is a diagram showing by way of example a reaction area (color irregularities) 103c developed by a color reaction with gas B;

FIG. 8 is a diagram showing a histogram of frequencies of signal intensities of color sample C;

FIG. 9 is a diagram showing by way of example a reaction area 103d developed during a color reaction;

FIG. 10 is a diagram showing a histogram of frequencies of signal intensities of color sample D;

FIG. 11 is a diagram showing by way of example a histogram of color sample A;

FIG. 12 is a diagram showing by way of example a histogram of color sample B;

FIG. 13 is a diagram showing by way of example a histogram of color sample C;

FIG. 14 is a diagram showing by way of example a histogram of color sample D;

FIG. 15 is a diagram showing by way of example a histogram generated from a reaction surface when the concentration of gas B is different from the concentration thereof at the time color sample C is produced;

FIG. 16 is a flowchart of an operation sequence of color identifying device 100 for storing data in histogram storage 5a;

FIG. 17 is a flowchart of an operation sequence of color identifying device 100 for identifying the color of reaction surface 103;

FIG. 18 is a diagram showing integrated values of D(1) and Dx at respective signal intensities and a calculated value of Dmulti(1); and

FIG. 19 is a diagram showing integrated values of D(5) and Dx at respective signal intensities and a calculated value of Dmulti(5).

### DETAILED DESCRIPTION OF THE PREFERRED EMBODIMENTS

Color identifying devices and color identifying methods according to exemplary embodiments of the present invention will be described below with reference to the accompanying drawings.

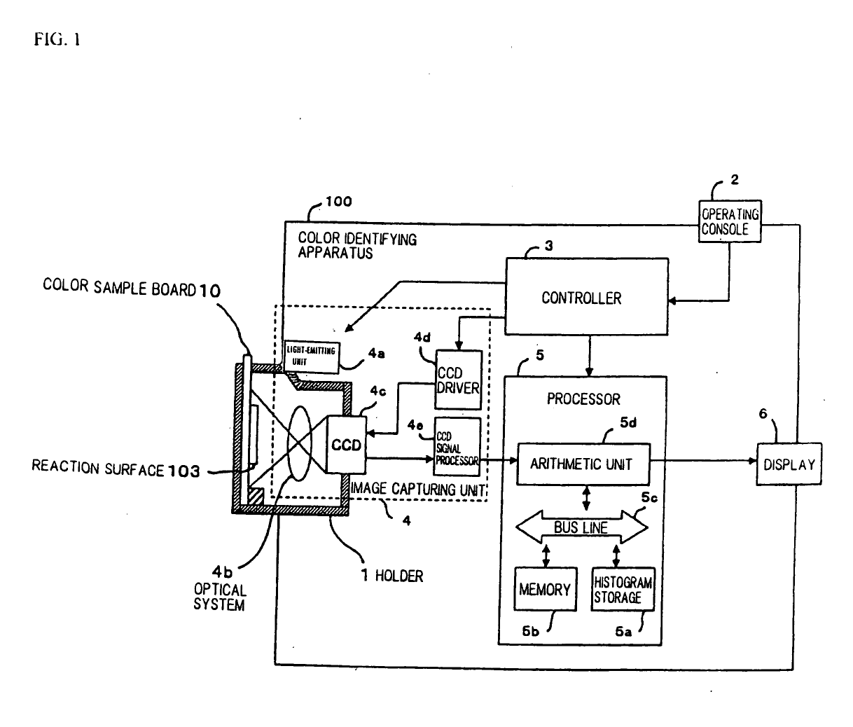

FIG. 1 shows in block form color identifying device 100 according to an exemplary embodiment of the present invention.

As shown in FIG. 1, color identifying device 100 comprises holder 1, operating console 2, controller 3, image capturing unit 4, processor 5 and display 6. Image capturing unit 4 includes light-emitting unit 4a, optical system 4b, CCD 4c, CCD driver 4d and CCD signal processor 4e. Processor 5 includes histogram storage 5a, memory 5b, bus line 5c and arithmetic unit 5d.

Color sample board 10 is mounted in a predetermined position in holder 1.

Color sample board 10 has reaction surface 103 disposed in a predetermined position thereon.

FIG. 2 shows in perspective color sample board 10 by way of example.

As shown in FIG. 2, color sample board 10 has a plurality of chemical reagents 101, a plurality of ampules 102 and a plurality of mediums 103. Ampules 102 contain chemical reagents 101, respectively, which are of different types. Mediums 103 are in the form of respective sheets of paper or the like. When ampules 102 are crushed, chemical reagents contained therein flow into mediums 103. Mediums 103 provide reaction surfaces 103, respectively.

When each chemical reagent 101 flows into medium 103, each chemical reagent 101 causes a color reaction with a gas, e.g., a gas to be identified, which is held in contact with medium 103. The M256 chemical agent detection kit disclosed in U.S. Pat. No. 6,228,657B1, for example, may be used as color sample board 10.

In FIG. 1, color identifying device 100 identifies the gas based on the colors of reaction surface 103 which has caused the color reaction.

Operating console 2 has an operation start button (not shown) which can be operated by the user. When the operation start button is operated, operating console 2 supplies a light emission instruction to controller 3.

In response to the light emission instruction from operating console 2, controller 3 controls operation of image capturing unit 4 and processor 5. Specifically, in response to the light emission instruction from operating console 2, controller 3 controls light-emitting unit 4a to emit light, supplies a drive signal to CCD driver 4d, and operates processor 5.

Image capturing unit 4 can generally be called image capturing means.

In response to an instruction from controller 3, image capturing unit 4 captures an image of reaction surface 103 of color sample board 10 that is mounted in holder 1, and generates RGB bitmap images (hereinafter referred to as “RGB bitmap data”) of reaction surface 103. Of the RGB, R stands for red, G for green, and B for blue.

Light-emitting unit 4a is controlled by controller 3 to apply light to reaction surface 103 of color sample board 10 mounted in holder 1. Light-emitting unit 4a comprises a halogen lamp or an LED, for example. However, light-emitting unit 4a is not limited to a halogen lamp or an LED, but may comprise another light source.

Reaction surface 103 reflects the light emitted from light-emitting unit 4a. When a color reaction is caused with a gas to be identified on reaction surface 103, the light reflected by reaction surface 103 represents a color that is generated by the color reaction. During the color reaction, reaction surface 103 may suffer color irregularities, developing a plurality of areas having different colors.

Holder 1 prevents light, which is different from the light emitted from light-emitting unit 4a, from being applied to color sample board 10.

Optical system 4b comprises a lens, for example, and produces an image of reaction surface 103 of color sample board 10 mounted in holder 1 onto CCD 4c.

CCD 4c is an example of a color image capturing device. The color image capturing device is not limited to a CCD, but may be any of other image capturing devices, e.g., a CMOS sensor.

In response to the drive signal from controller 3, CCD driver 4d operates CCD 4c to capture a color image of reaction surface 103 which is formed on CCD 4c. CCD 4c supplies an analog color image signal representing the captured color image of reaction surface 103 to CCD signal processor 4e.

CCD signal processor 4e converts the analog color image signal from CCD 4c into a digital signal (RGB bitmap data), and supplies the RGB bitmap data to processor 5.

According to the RGB bitmap data, each bit (pixel) is represented by R, G, B signals each having a signal intensity in a range from 0 to 255. The signal intensity range of each of the R, G, B signals is not limited to 0 to 255, but may be another range.

Processor 5 processes the RGB bitmap data from CCD signal processor 4e to identify the color of reaction surface 103, and outputs information depending on the identified color.

Histogram storage 5a can generally be called histogram storage means.

Histogram storage 5a stores a plurality of associated sets of identifying information and a reference histogram of R, G, B signal intensities, which are generated from RGB bitmap data images of reaction surfaces which have caused color reactions with gases, and the frequencies of the signal intensities. The identifying information is used for identifying the reaction surfaces.

Memory 5b is used as a working memory of arithmetic unit 5d.

Arithmetic unit 5d can generally be called arithmetic means.

Arithmetic unit 5d operates by executing a program, for example. Arithmetic unit 5d is connected to histogram storage 5a and memory 5b by bus line 5c.

Arithmetic unit 5d generates a histogram of signal intensities and frequencies thereof from the RGB bitmap data generated by image capturing unit 4. The signal intensities are assigned to the R, G, B signals of each bit. According to the present exemplary embodiment, the frequency of a certain signal intensity represents the number of bits indicating the signal intensity.

Arithmetic unit 5d checks the generated histogram against the reference histograms stored in histogram storage 5a, and identifies the reference histogram which matches the generated histogram.

For example, arithmetic unit 5d specifies one of the reference histograms stored in histogram storage 5a that includes signal intensities at frequency peaks which are closest to the signal intensities at the frequency peaks of the generated histogram.

Specifically, arithmetic unit 5d calculates the products of the signal frequencies at the same signal intensities of the generated histogram and each of the reference histograms, adds the products, and specifies the identifying information that is related to the reference histogram whose sum of the products is the greatest.

Arithmetic unit 5d outputs the identifying information that is related to the specified reference histogram to display 6.

Display 6 can generally be called output means.

Display 6 is an example of an output unit and displays the identifying information specified by arithmetic unit 5d. The output unit is not limited to the display, but may be another output unit such as a speech output unit for outputting a speech signal representing the specified identifying information.

The reference histograms stored in histogram storage 5a should preferably be histograms of RGB signal intensities generated by arithmetic unit 5d from RGB bitmap images captured in advance by image capturing unit 4 that represent reaction surfaces on which color reactions have been caused with gases, and the frequencies of the signal intensities.

However, the reference histograms stored in histogram storage 5a are not limited to histograms generated by arithmetic unit 5d.

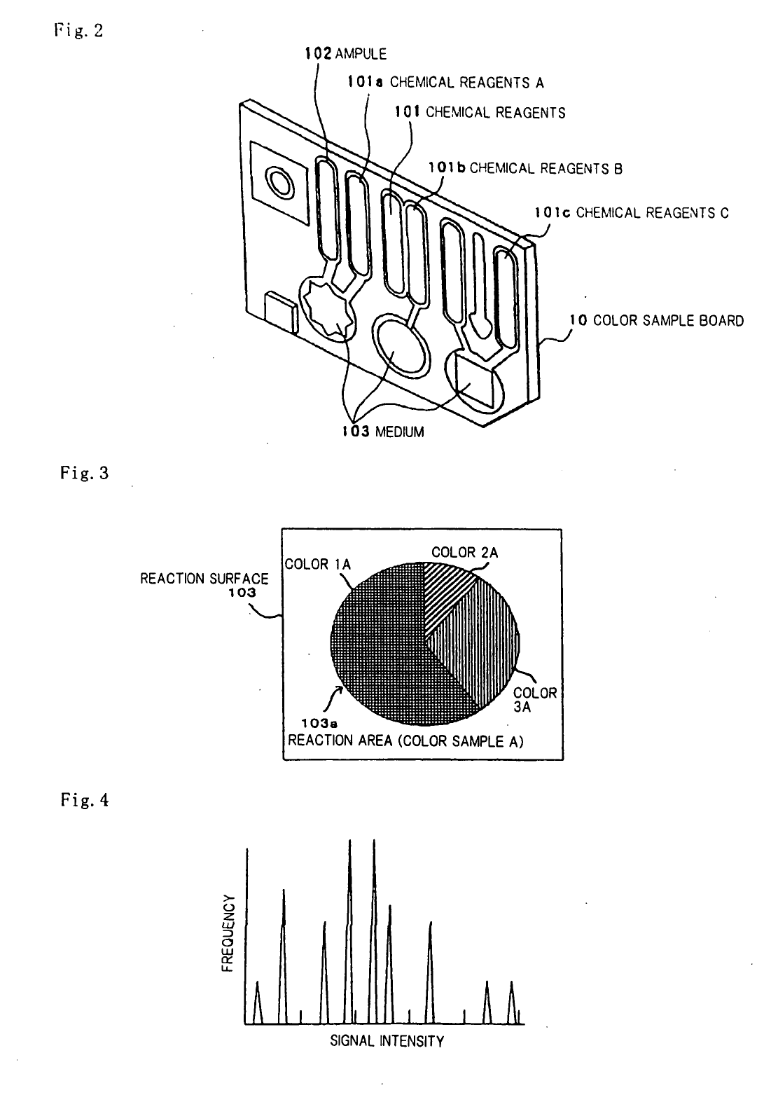

The relationship between reaction surface 103 of color sample board 10 and a histogram generated by arithmetic unit 5d will be described below. FIG. 3 is a diagram showing by way of example reaction surface 103 on which a color reaction has been caused with a certain gas (gas A).

In FIG. 3, reaction surface 103, which is white, has circular reaction area (color irregularities) 103b developed by the color reaction with gas A, circular reaction area 103a containing color 1A, color 2A, and color 3A. Reaction area (color irregularities) 103b will hereinafter be referred to as color sample A.

When image capturing unit 4 captures an image of color sample A, image capturing unit 4 produces a RGB bitmap data representative of reaction surface 103 having color sample A. Arithmetic unit 5d converts the RGB bitmap images into a histogram of data representing RGB signal intensities of the pixels and the frequencies of the signal intensities.

Specifically, arithmetic unit 5d generates R, G, B histograms and then generates a single histogram by combining the R, G, B histograms using the signal intensities as a common axis.

FIG. 4 is a diagram showing a histogram of frequencies of signal intensities of color sample A.

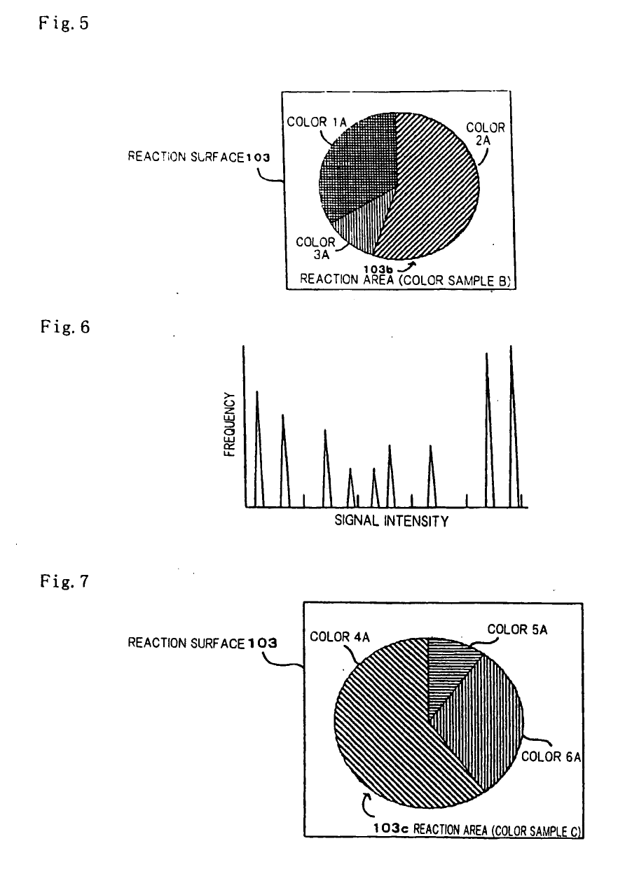

FIG. 5 is a diagram showing by way of example circular reaction area (color irregularities) 103b developed by the color reaction with gas A, circular reaction area 103b containing color 1A, color 2A, and color 3A at different area ratios. Reaction area (color irregularities) 103b shown in FIG. 5 will hereinafter be referred to as color sample B.

FIG. 6 is a diagram showing a histogram of frequencies of signal intensities of color sample B.

The types of the colors in the reaction areas of color samples A, B are the same as each other because reaction surfaces 103 of both color samples A, B have reacted with gas A. Therefore, the signal intensities occurring at the frequency peaks of the histogram shown in FIG. 4 are the same as the signal intensities occurring at the frequency peaks of the histogram shown in FIG. 6. However, the values of the frequency peaks of the histogram shown in FIG. 4 are different from the values of the frequency peaks of the histogram shown in FIG. 6 because the area ratios of the colors in the reaction areas are different from each other.

Consequently, even if a plurality of reaction surfaces which have caused color reactions with the same gas have different area ratios of colors developed during the color reactions, those reaction surfaces having the different area ratios of colors can be specified as having caused color reactions with the same gas provided that their signal intensities occurring at the frequency peaks match each other.

FIG. 7 is a diagram showing by way of example that reaction surface 103, which is white, has circular reaction area (color irregularities) 103c developed by a color reaction with gas B, circular reaction area 103c containing color 4A, color 5A, and color 6A. Reaction area (color irregularities) 103c shown in FIG. 7 will hereinafter be referred to as color sample C.

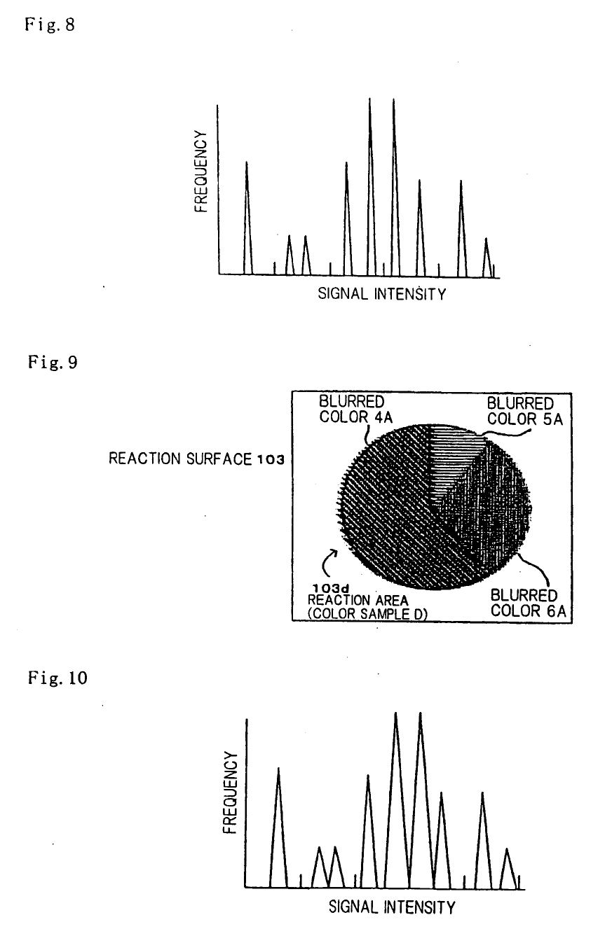

FIG. 8 is a diagram showing a histogram of frequencies of signal intensities of color sample C.

Since color sample C and color sample A are generated by the color reactions with the different gases, the colors of color sample C and color sample A which are generated by the color reactions are different from each other. Therefore, the signal intensities at the frequency peaks of the histogram shown in FIG. 4 are different from the values of the frequency peaks of the histogram shown in FIG. 8.

FIG. 9 is a diagram showing by way of example circular reaction area (color irregularities) 103d developed during a color reaction, reaction area 103d representing a blurred version of reaction area 103c. Reaction area (color irregularities) 103d 9 will hereinafter be referred to as color sample D.

FIG. 10 is a diagram showing a histogram of frequencies of signal intensities of color sample D.

Since color sample C and color sample D contain the same major colors, the signal intensities at the frequency peaks of the histogram shown in FIG. 8 are the same as the signal intensities at the frequency peaks of the histogram shown in FIG. 10. However, as color sample D represents a blurred version of color sample C and contains color components that are not present in color sample C, the signal intensities of color sample D have their values dispersed and the values of the frequency peaks thereof are reduced.

Consequently, even if a plurality of reaction surfaces, which have caused color reactions with the same gas, have colors blurred during the color reactions, those reaction surfaces with the blurred colors can be specified as having caused color reactions with the same gas provided that their signal intensities that occur at the frequency peaks match each other.

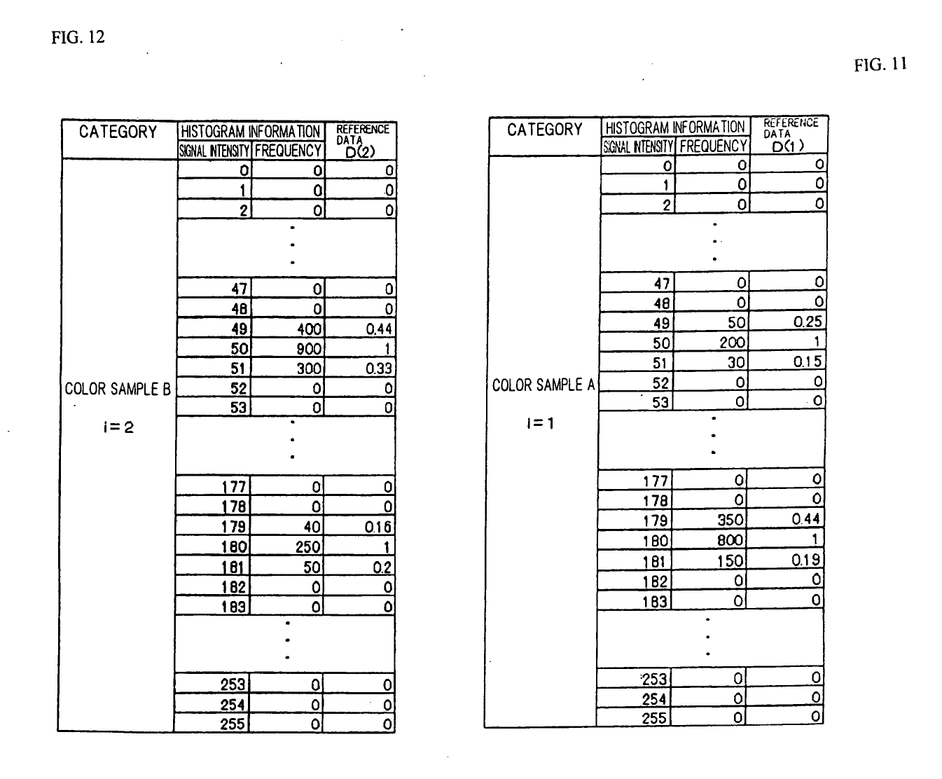

FIG. 11 is a diagram showing by way of example a reference histogram of color sample A (i=1) stored in histogram storage 5a. The reference histogram shown in FIG. 11 is generated by arithmetic unit 5d and is stored in histogram storage 5a in association with a category “COLOR SAMPLE A (i=1)” which serves as identifying information for identifying color sample A (i=1).

The reference histogram shown in FIG. 11 represents the frequencies of signal intensities (0 through 255) of RGB bitmap data of color sample A.

As shown in FIG. 11, the frequency of signal intensity 50 is 200 and provides a frequency peak at this position (signal intensity 50). Arithmetic unit 5d sets the value of reference data D (i=1) at signal intensity 50 to 1, and standardizes nearby reference data such that the value of reference data D (1) at signal intensity 49 is set to 1/200×50=0.25 and the value of reference data D (1) at signal intensity 51 is set to 1/200×30=0.15.

As shown in FIG. 11, the frequency of signal intensity 180 is 800 and provides a frequency peak at this position (signal intensity 180). Arithmetic unit 5d sets the value of reference data D (1) at signal intensity 180 to 1, and standardizes nearby reference data such that the value of reference data D (1) at signal intensity 179 is set to 1/800×350=0.44 and the value of reference data D (1) at signal intensity 51 is set to 1/800×150=0.19.

In FIG. 11, reference data D (1) also represents the frequencies of signal intensities.

FIG. 12 is a diagram showing by way of example a reference histogram of color sample B (i=2) stored in histogram storage 5a. The reference histogram shown in FIG. 12 is generated by arithmetic unit 5d and is stored in histogram storage 5a in association with a category “COLOR SAMPLE B (i=2)” which serves as identifying information for identifying color sample B (i=2).

The reference histogram shown in FIG. 12 represents the frequencies of signal intensities (0 through 255) of RGB bitmap data of color sample B.

As shown in FIG. 12, the frequency of signal intensity 50 is 900 and provides a frequency peak at this position (signal intensity 50). Arithmetic unit 5d sets the value of reference data D (i=2) at signal intensity 50 to 1, and standardizes nearby reference data such that the value of reference data D (2) at signal intensity 49 is set to 1/900×400=0.44 and the value of reference data D (1) at signal intensity 51 is set to 1/900×300=0.33.

As shown in FIG. 12, the frequency of signal intensity 180 is 250 and provides a frequency peak at this position (signal intensity 180). Arithmetic unit 5d sets the value of reference data D (2) at signal intensity 180 to 1, and standardizes nearby reference data such that the value of reference data D (2) at signal intensity 179 is set to 1/250×40=0.16 and the value of reference data D (2) at signal intensity 51 is set to 1/250×50=0.2.

In FIG. 12, reference data D (2) also represents the frequencies of signal intensities.

The reference histogram shown in FIG. 11 and the reference histogram shown in FIG. 12 have the same signal intensities, but different frequencies, at the frequency peaks.

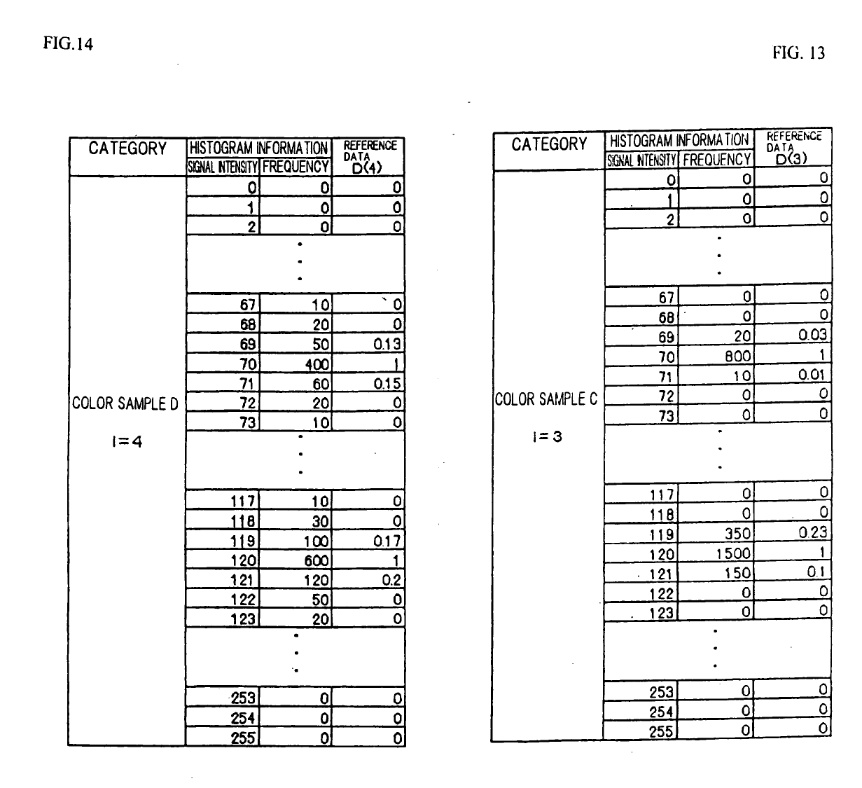

FIG. 13 is a diagram showing by way of example a reference histogram of color sample C (i=3) stored in histogram storage 5a. FIG. 14 is a diagram showing by way of example a reference histogram of color sample D (i=4) stored in histogram storage 5a.

Since color sample D is blurred, the reference histogram shown in FIG. 14 has a greater dispersion, i.e., is more spreading, than the reference histogram shown in FIG. 13.

FIG. 15 is a diagram showing by way of example a reference histogram of color sample E (i=5) which is generated from reaction surface 103 when the concentration of gas B is different from the concentration thereof at the time color sample C is produced. Since the concentration of the gas is related to the brightness of the color reaction area, the signal intensities at frequency peaks differ if the concentration of the gas differs though the gas remains the same.

According to the present exemplary embodiment, the user prepares a plurality of color sample boards 10 whose reaction surfaces 103 have chemically reacted with different gases at different concentrations, and successively places those color sample boards 10 in holder 1. Arithmetic unit 5d generates histograms of reaction surfaces 103 of those color sample boards 10, and stores the generated histograms as reference histograms in histogram storage 5a.

Operation of color identifying device 100 according to the present exemplary embodiment will be described below.

Color identifying device 100 stores reference histograms and identifying information thereof in histogram storage 5a. Thereafter, color identifying device 100 identifies the colors of reaction surface 103 based on RGB bitmap data of reaction surface 103 which are generated by image capturing unit 4 and the reference histograms stored in histogram storage 5a, and outputs information representing the identified color.

First, an operation sequence of color identifying device 100 for storing data in histogram storage 5a will be described below. This operation sequence is carried out after color identifying device 100 is brought into a reference data generating mode when the user operates a reference data generating button (not shown) on operating console 2.

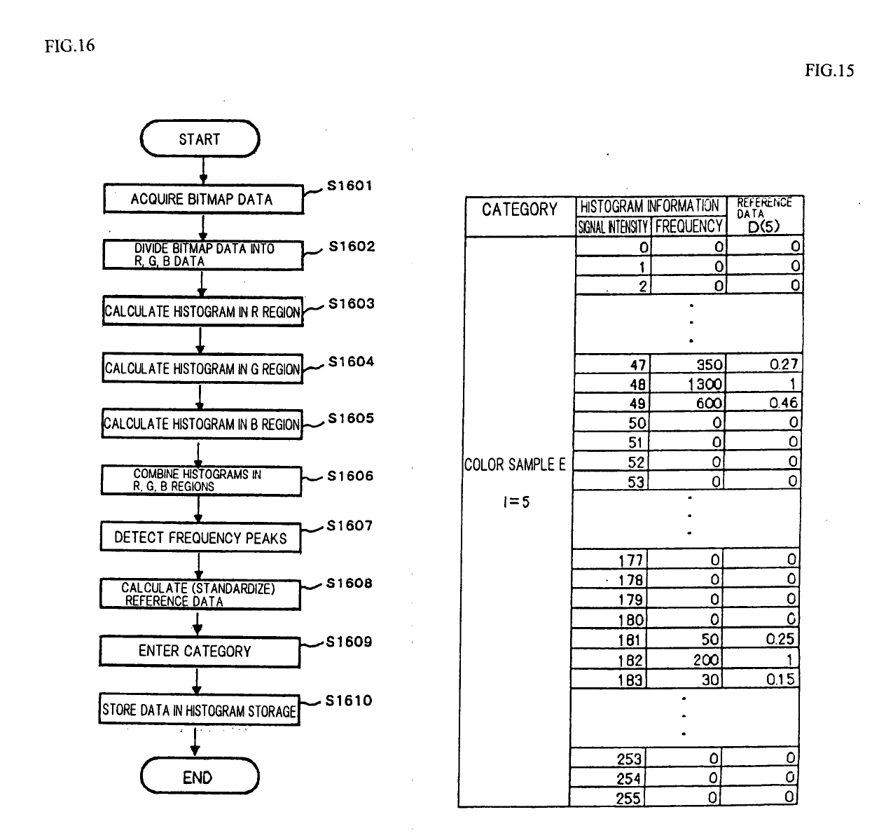

FIG. 16 is a flowchart showing the operation sequence of color identifying device 100 for storing data in histogram storage 5a.

The user inserts color sample board 10 having reaction surface 103 which has caused a color reaction with a specified gas into a given position in holder 1. The concentration of the gas is also specified in advance.

When the user operates an operation start button in operating console 2 under the reference data generating mode, operating console 2 supplies a light emission instruction to controller 3.

In response to the light emission instruction from operating console 2, controller 3 controls light-emitting unit 4a to emit light, supplies a drive signal to CCD driver 4d, and operates processor 5.

Reaction surface 103 reflects the light emitted from light-emitting unit 4a, and optical system 4b focuses an image of reaction surface 103 onto CCD 4c. Based on a drive signal from controller 3, CCD driver 4d energizes CCD 4c to capture the image of reaction surface 103 on CCD 4c.

CCD 4c supplies an analog color image signal representing the captured image of reaction surface 103 to CCD signal processor 4e. CCD signal processor 4e converts the analog color image signal into RGB bitmap data, and supplies the RGB bitmap data to arithmetic unit 5d.

Arithmetic unit 5d acquires the RGB bitmap data in step 1601.

Then, in step 1602, arithmetic unit 5d divides the RGB bitmap data into signal intensity data in respective R, G, B regions, and sends the signal intensity data in the respective R, G, B regions through bus line 5c to memory 5b where the signal intensity data in the respective R, G, B regions are stored.

Then, arithmetic unit 5d calculates a histogram of signal intensities in the R region in order to obtain frequency data for the signal intensities in the R region (a histogram with respect to R). For example, arithmetic unit 5d refers to memory 5b and counts the number of bits (pixels) in the R region which represent signal intensities in the range from 0 to 255 in step 1603.

Then, arithmetic unit 5d calculates a histogram of signal intensities in the G region in order to obtain frequency data for the signal intensities in the G region (a histogram with respect to G). For example, arithmetic unit 5d refers to memory 5b and counts the number of bits (pixels) in the G region which represent the signal intensities in the range from 0 to 255 in step 1604.

Then, arithmetic unit 5d calculates a histogram of signal intensities in the B region in order to obtain frequency data for the signal intensities in the B region (a histogram with respect to B). For example, arithmetic unit 5d refers to memory 5b and counts the number of bits (pixels) in the B region which represent the signal intensities in the range from 0 to 255 in step 1605.

Then, arithmetic unit 5d generates a single histogram by combining the R, G, B histograms using the signal intensities as a common axis, and stores the generated combined histogram in memory 5b in step 1606.

Then, arithmetic unit 5d refers to memory 5b and detects frequency peak values of the combined histogram in step 1607.

Then, arithmetic unit 5d sets reference data D(i) of the signal intensities at frequency peaks to “1”, and also sets reference data D(i) of nearby signal intensities to values produced by standardizing the frequencies at those nearby intensities depending on the corresponding frequency peak values in step 1608.

Then, arithmetic unit 5d displays a message for prompting the user to enter a category such as a data name or the like, on display 6. When the user operates operating console 2 based on a message to enter a category, operating console 2 supplies the entered category to controller 3, which supplies the category to arithmetic unit 5d in step 1609.

The category will be used as a data name when finally identified data are displayed on display 6.

When arithmetic unit 5d receives the category, arithmetic unit 5d associates the category with the data generated so far, i.e., the histogram generated in step 1606 and the reference data generated in step 1608, and stores all the data as a lump in histogram storage 5a through bus line 5c in step 1610. The histogram generated in step 1606 and the reference data generated in step 1608 jointly make up a reference histogram.

Thereafter, the operation sequence shown in FIG. 16 is repeated as the user changes color sample board 10 in holder 1 with successive color sample boards 10 whose reaction surfaces 103 have chemically reacted with different gases at different concentrations.

First, an operation sequence of color identifying device 100 in which arithmetic unit 5d identifies the colors of reaction surface 103 based on RGB bitmap data of reaction surface 103 generated by image capturing unit 4 and the reference histograms stored in histogram storage 5a, and outputs information representing the identified color will be described below. This operation sequence is carried out after the reference data generating mode is canceled when the user operates the reference data generating button on operating console 2.

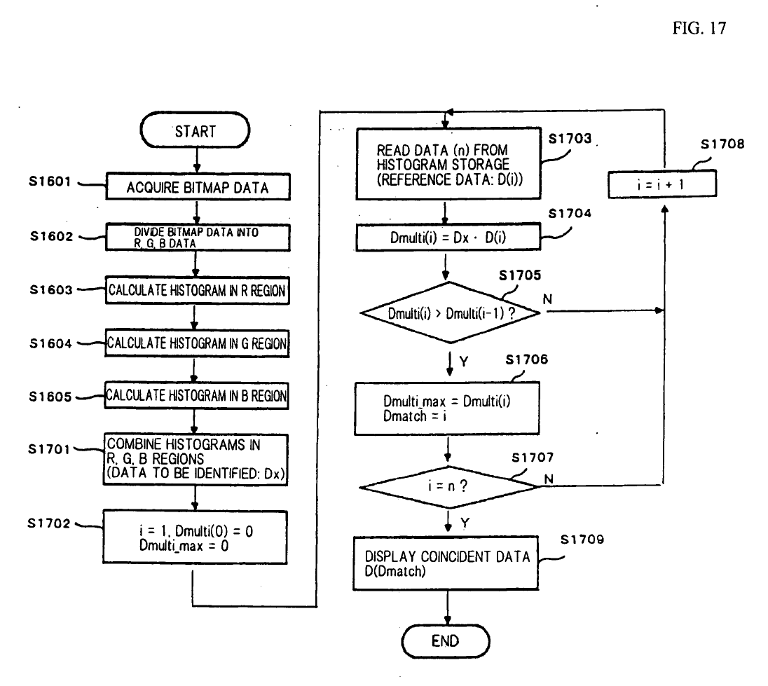

FIG. 17 is a flowchart of an operation sequence of color identifying device 100 for identifying the color of reaction surface 103. Those steps of FIG. 17 which are identical to those shown in FIG. 16 are denoted by identical reference characters.

The user inserts color sample board 10 having reaction surface 103, which has caused a color reaction with a specified gas, into a given position in holder 1.

When the user operates the operation start button on operating console 2 with the reference data generating mode being canceled, light-emitting unit 4a emits light, and CCD 4c captures an image of reaction surface 103 and supplies an analog color image signal representing the captured image of reaction surface 103 to CCD signal processor 4e. CCD signal processor 4e converts the analog color image signal into RGB bitmap data, and supplies the RGB bitmap data to arithmetic unit 5d.

Arithmetic unit 5d acquires the RGB bitmap data in step 1601. Thereafter, arithmetic unit 5d executes steps 1602 through 1605.

Then, arithmetic unit 5d generates a single histogram Dx by combining the R, G, B histograms using the signal intensities as a common axis, and stores generated combined histogram Dx in memory 5b in step 1701.

Then, arithmetic unit 5d sets variable i to “1” and sets arithmetic initial values to “0” (Dmulti(0)=0, Dmulti_max=0) in step 1702.

Then, arithmetic unit 5d reads the data corresponding to variable i from histogram storage 5a, and stores the read data in memory 5b through bus line 5c in step 1703.

Then, arithmetic unit 5d refers to memory 5b, calculates products of Dx and D(i) at the respective same signal intensities, and adds the products, producing sum value Dmulti(i) in step 1704.

Then, arithmetic unit 5d determines whether Dmulti(i) is greater than Dmulti(i−1) or not in step 1705.

If Dmulti(i) is greater than Dmulti(i−1), then arithmetic unit 5d establishes Dmulti_max=Dmulti(i) and Dmatch=1 in step 1706.

Then, arithmetic unit 5d determines whether i=n or not in step 1707. “n” represents the number of reference histograms stored in histogram storage 5a.

If i is not n, then arithmetic unit 5d increments variable i by 1 in step 1708, and executes step 1703.

If Dmulti(i) is not greater than Dmulti(i−1) in step 1705, then arithmetic unit 5d executes step 1708.

If i=n, then arithmetic unit 5d displays the category corresponding to i indicated by Dmatch as data corresponding to reaction surface 103 in holder 1 in step 1709.

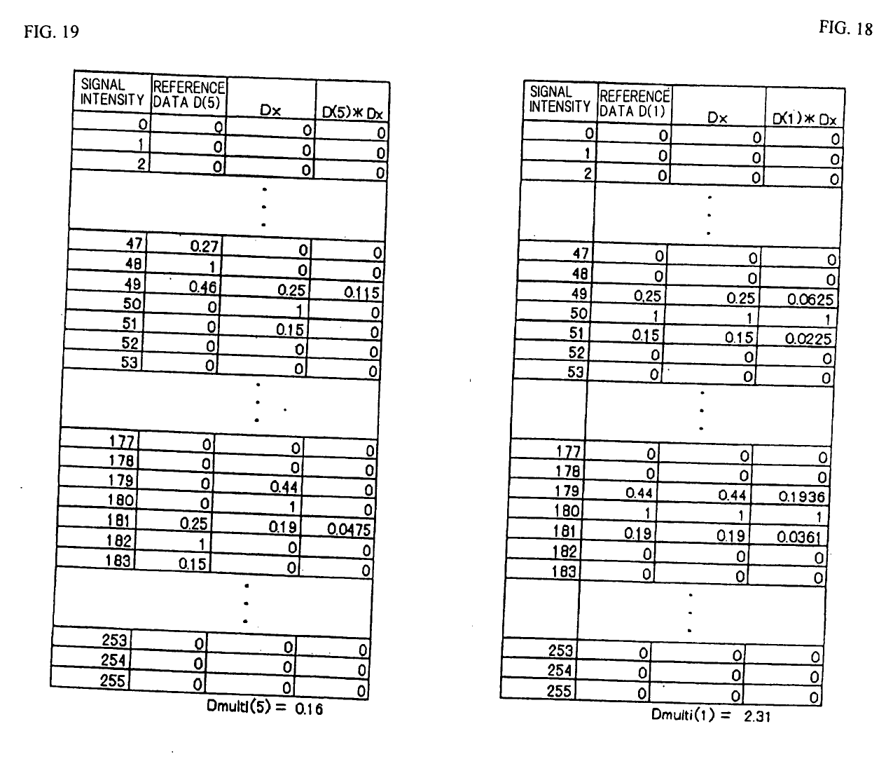

FIG. 18 is a diagram showing integrated values of D(1) and Dx at respective signal intensities and a calculated value of Dmulti(1), and FIG. 19 is a diagram showing integrated values of D(5) and Dx at respective signal intensities and a calculated value of Dmulti(5).

In FIG. 18, Dmulti(1)=2.31, and in FIG. 19, Dmulti(t)=0.16. Therefore, reference data D(1) exhibit a higher degree of coincidence with reaction surface 103 in holder 1.

According to the present exemplary embodiment, arithmetic unit 5d checks the histogram, which is generated from the RBP bitmap data from image capturing unit 4, against the reference histograms, specifies one of the reference histograms which corresponds to the generated histogram, and specifies a category that is related to the specified reference histogram.

The histogram indicates individual features of different colors on reaction surface 103. Therefore, even if reaction surface 103 suffers color irregularities, the histogram is capable of indicating the individual features of the colors on reaction surface 103.

Consequently, even if reaction surface 103 suffers color irregularities during the color reaction, the color of reaction surface 103 can be identified with high accuracy.

A color identifying apparatus, which consists of histogram storage 5a, image capturing unit 4, arithmetic unit 5d and display 6, operates in the same manner and offers the same advantages as color identifying apparatus 100 according to the present exemplary embodiment. In other words, the color identifying apparatus having histogram storage 5a, image capturing unit 4, arithmetic unit 5d and display 6 is capable of identifying the color of reaction surface 103 with high accuracy even if reaction surface 103 suffers color irregularities during the color reaction.

According to the present exemplary embodiment, arithmetic unit 5d specifies one of the reference histograms whose signal intensities at frequency peaks are closest to those of the histogram generated from the RBP bitmap data from image capturing unit 4, and specifies a category related to the specified reference histogram.

If the colors developed on the reaction surface remain the same, then the signal intensities at frequency peaks do not vary even when the areas of the colors change.

Therefore, even if the area ratios of the colors that are developed on the reaction surface during the color reaction vary, the color of the reaction surface can be identified with high accuracy without being adversely affected by the variations of the area ratios of the colors.

According to the present exemplary embodiment, arithmetic unit 5d calculates the products of the frequencies of the same signal intensities of the generated histogram and each of the reference histograms, adds the products, and specifies a category which is related to the reference histogram whose sum of the products is the greatest.

In this case, it is possible to specify, by way of calculations, one of the histograms stored in histogram storage 5a whose signal intensities at frequency peaks are closest to those of the histogram of RGB bitmap images captured by image capturing unit 4.

According to the present exemplary embodiment, histogram storage 5a stores, as reference histograms, a plurality of histograms of R, G, B signal intensities and frequencies thereof that are generated by arithmetic unit 5d from RGB bitmap images that are captured in advance by image capturing unit 5 of reaction surfaces 103 which have caused color reactions with gases.

The reference histograms stored in histogram storage 5a represent information that depends on the characteristics of image capturing unit 4, making it easy to match the reference histograms stored in histogram storage 5a and the image capturing characteristics of image capturing unit 4.

A category stored in histogram storage 5a may comprise gas identifying information (e.g., gas names and gas concentrations) for identifying a gas which has chemically reacted with the reaction surface identified by the category.

It is thus possible to output identifying information for identifying a gas which has chemically reacted with reaction surface 103. Therefore, it is easy to specify the gas which has chemically reacted with the reaction surface.

According to the above exemplary embodiment, the color of a reaction surface is identified by using a histogram of the RGB signal intensities generated from RGB bitmap images of the reaction surface and the frequencies of the signal intensities. The histogram indicates individual features of different colors on the reaction surface. Therefore, even if the reaction surface suffers color irregularities, the histogram is capable of indicating the individual features of the colors on the reaction surface.

Consequently, even if the reaction surface suffers color irregularities during the color reaction, the color of the reaction surface can be identified with high accuracy.

The arithmetic unit should preferably specify one of the reference histograms whose signal intensities at frequency peaks are closest to those of the generated histogram, and should preferably specify identifying information related to the specified reference histogram.

If the colors developed on the reaction surface remain the same, then the signal intensities at frequency peaks do not vary even when the areas of the colors change.

According to the above exemplary embodiment, therefore, even if the area ratios of the colors that are developed on the reaction surface during the color reaction vary, the color of the reaction surface can be identified with high accuracy without being adversely affected by the variations of the area ratios of the colors.

The arithmetic unit should preferably calculate the products of the frequencies of the same signal intensities of the generated histogram and each of the reference histograms, add the products, and specify identifying information which is related to the reference histogram whose sum of the products is the greatest.

According to the above exemplary embodiment, it is possible to specify, by way of calculations, one of the histograms stored in the histogram storage whose signal intensities at frequency peaks are closest to those of the histogram of RGB bitmap images captured by the image capturing unit.

The histogram storage stores, as reference histograms, a plurality of histograms of R, G, B signal intensities and frequencies thereof that are generated by the arithmetic unit from RGB bitmap images that are captured in advance by the image capturing unit of reaction surfaces which have caused color reactions with gases.

According to the above exemplary embodiment, the reference histograms stored in the histogram storage represent information that depends on the characteristics of the image capturing unit, making it easy to match the reference histograms stored in the histogram storage and the image capturing characteristics of the image capturing unit.

The identifying information stored in the histogram storage should preferably comprise gas identifying information for identifying a gas which has chemically reacted with the reaction surface identified by the identifying information.

According to the above exemplary embodiments, it is thus possible to output identifying information for identifying a gas which has chemically reacted with the reaction surface. Therefore, it is easy to specify the gas which has chemically reacted with the reaction surface.

An exemplary advantage according to the present invention is that the color of the reaction surface can be identified with high accuracy even if the reaction surface suffers color irregularities during the color reaction.

While an exemplary embodiment of the present invention has been described using specific terms, such description is for illustrative purposes only, and it is to be understood that changes and variations may be made without departing from the spirit or scope of the following claims.

What is claimed is:

1. A color identifying apparatus for identifying a color of a reaction surface which has caused a color reaction with a gas to be specified, comprising:
a histogram storage that stores a plurality of associated sets of identifying information and a reference histogram of R, G, B signal intensities, which are generated from RGB bitmap data images of reaction surfaces which have caused color reactions with gases, and frequencies of the signal intensities, said identifying information being used for identifying the reaction surfaces;
an image capturing unit that captures an image of the reaction surface and generates RGB bitmap images of the reaction surface;
an arithmetic unit that generates a histogram of RGB signal intensities and the frequencies thereof from the RGB bitmap images generated by said image capturing unit, checks the generated histogram against the reference histograms stored in the histogram storage to specify one of the reference histograms which corresponds to the generated histogram, and specifies the identifying information which is related to the specified reference histogram; and
an output unit that outputs the identifying information specified by said arithmetic unit.

2. The color identifying apparatus according to claim 1, wherein said arithmetic unit specifies one of the reference histograms whose signal intensities at frequency peaks are closest to those of said generated histogram, and specifies identifying information which is related to the specified reference histogram.

3. The color identifying apparatus according to claim 2, wherein said arithmetic unit calculates products of the frequencies of the same signal intensities of said generated histogram and each of said reference histograms, adds the products, and specifies identifying information which is related to the reference histogram whose sum of the products is the greatest.

4. The color identifying apparatus according to claim 1, wherein said histogram storage stores, as the reference histograms, a plurality of histograms of R, G, B signal intensities and frequencies thereof that are generated by said arithmetic unit from RGB bitmap images that are captured in advance by said image capturing unit with regard to reaction surfaces which have caused color reactions with gases.

5. The color identifying apparatus according to claim 1, wherein said identifying information comprises gas identifying information for identifying a gas which has chemically reacted with the reaction surface identified by the identifying information.

6. A color identifying apparatus for identifying a color of a reaction surface which has caused a color reaction with a gas to be specified, comprising:
histogram storage means for storing a plurality of associated sets of identifying information and a reference histogram of R, G, B signal intensities, which are generated from RGB bitmap data images of reaction surfaces which have caused color reactions with gases, and frequencies of the signal intensities, said identifying information being used for identifying the reaction surfaces;
image capturing means for capturing an image of the reaction surface and generating RGB bitmap images of the reaction surface;
arithmetic means for generating a histogram of RGB signal intensities and the frequencies thereof from the RGB bitmap images generated by said image capturing means, checking the generated histogram against the reference histograms stored in the histogram storage means to specify one of the reference histograms which corresponds to the generated histogram, and specifying the identifying information which is related to the specified reference histogram; and
output means for outputting the identifying information specified by said arithmetic means.

7. A color identifying method adapted to be carried out by a color identifying apparatus including a histogram storage, comprising:
storing, in the histogram storage, a plurality of associated sets of identifying information and a reference histogram of R, G, B signal intensities, which are generated from RGB bitmap data images of reaction surfaces which have caused color reactions with gases, and frequencies of the signal intensities, said identifying information being used for identifying the reaction surfaces;
capturing an image of the reaction surface and generating RGB bitmap images of the reaction surface;
generating a histogram of RGB signal intensities and the frequencies thereof from the generated RGB bitmap images;
specifying one of the reference histograms which corresponds to the generated histogram by checking the generated histogram against the reference histograms stored in said histogram storage;
specifying the identifying information which is related to the specified reference histogram; and
outputting the specified identifying information.

8. The color identifying method according to claim 7, wherein said specifying the identifying information comprises specifying one of the reference histograms whose signal intensities at frequency peaks are closest to those of said generated histogram.

9. The color identifying method according to claim 8, wherein said specifying the identifying information comprises calculating products of the frequencies of the same signal intensities of said generated histogram and each of said reference histograms, adding the products, and specifying the reference histogram whose sum of the products is the greatest.

10. The color identifying method according to claim 7, wherein said storing comprises storing, as the reference histograms, a plurality of histograms of R, G, B signal intensities and frequencies thereof that are generated in advance by said color identifying apparatus.

11. The color identifying method according to claim 7, wherein said identifying information comprises gas identifying information for identifying a gas which has chemically reacted with the reaction surface identified by the identifying information.
